(19) United States
(12) Patent Application Publication
(10) Pub. No.: US 2014/0063533 A1
(43) Pub. Date: Mar. 6, 2014

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Yuji KAZAMA, Kanagawa (JP)

(73) Assignee: FUJI XEROX CO., LTD., Tokyo (JP)

(21) Appl. No.: 13/747,001

(22) Filed: Jan. 22, 2013

(30) Foreign Application Priority Data
Aug. 28, 2012 (JP) 2012-187333

(51) Int. Cl. G06F 3/12

(52) U.S. Cl. CPC G06F 3/1237
USPC 358/1.14

(57) ABSTRACT

An information processing apparatus includes a receiving unit that receives a reason why to input a setting other than a predetermined print setting when printing is performed, and a calculating unit that, using a print log, collects a total print sheet count of sheets printed for each print requester, a print sheet count of sheets printed at the predetermined print setting, and a print sheet count of sheets printed for the reason, and calculates a reducible print sheet count of the print requester in accordance with calculated information of the print sheet counts.

### CROSS-REFERENCE TO RELATED APPLICATIONS

This application is based on and claims priority under 35 USC 119 from Japanese Patent Application No. 2012-187333 filed Aug. 28, 2012.

### BACKGROUND

### Technical Field

The present invention relates to an information processing apparatus, an information processing method, and a non-transitory computer readable medium.

### SUMMARY

According to an aspect of the invention, there is provided an information processing apparatus, including a receiving unit that receives a reason why to input a setting other than a predetermined print setting when printing is performed, and a calculating unit that, using a print log, collects a total print sheet count of sheets printed for each print requester, a print sheet count of sheets printed at the predetermined print setting, and a print sheet count of sheets printed for the reason, and calculates a reducible print sheet count of the print requester in accordance with calculated information of the print sheet counts.

### BRIEF DESCRIPTION OF THE DRAWINGS

Exemplary embodiments of the present invention will be described in detail based on the following figures, wherein:

FIG. 1 illustrates a modular configuration of an exemplary embodiment;

FIG. 2 illustrates a modular configuration of the exemplary embodiment;

FIGS. 3A and 3B illustrate an example of a print attribute setting screen;

FIG. 4 illustrates a data structure of a print attribute table;

FIG. 5 is a flowchart illustrating an example of a process of the exemplary embodiment;

FIG. 6 illustrates a modular configuration of the exemplary embodiment;

FIG. 7 illustrates a data structure of a print log table;

FIG. 8 illustrates a data structure of an energy-saving unexecuted data table of each user;

FIG. 9 is a flowchart illustrating an example of a process of the exemplary embodiment;

FIG. 10 illustrates a modular configuration of the exemplary embodiment;

FIG. 11 illustrates an example of a data structure of a target category;

FIG. 12 illustrates an example of a data structure of a personal yearly target schedule table;

FIG. 13 is a flowchart illustrating a process of the exemplary embodiment;

FIG. 14 illustrates a modular configuration of the exemplary embodiment;

FIG. 15 illustrates an example of a data structure of a personal yearly target schedule and record table;

FIG. 16 illustrates an example of a data structure of an energy-saving action table;

FIG. 17 illustrates an example of a displayed energy-saving action comment;

FIG. 18 is a flowchart illustrating an example of a process of the exemplary embodiment; and

FIG. 19 is a block diagram illustrating hardware of a computer implementing the exemplary embodiment.

### DETAILED DESCRIPTION

An exemplary embodiment of the present invention is described below with reference to the drawings.

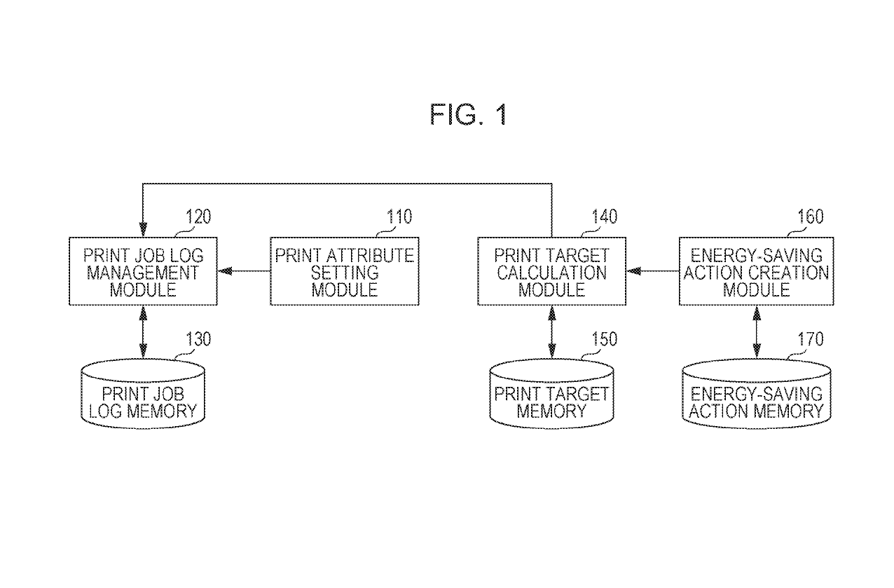

FIG. 1 illustrates a configuration of modules of the exemplary embodiment.

The word “module” refers to a software component that is logically separable (a computer program or simply a program), or a hardware component. The module of the exemplary embodiment refers to not only a module in a computer program but also a module in a hardware structure. The discussion of the exemplary embodiments also serves as the discussion of computer programs for causing the modules to function (including a program that causes a computer to execute each step, a program that causes the computer to function as an element, and a program that causes the computer to implement each function), a system and a method. In the discussion that follows, the phrases “stores information,” “causes information to be stored,” and other phrases equivalent thereto are used. If an exemplary embodiment is a computer program, these phrases are intended to express “causes a memory device to store information” or “controls a memory device to cause the memory device to store information.” The modules may correspond to the functions in a one-to-one correspondence. In a software implementation, one module may be composed of one program or multiple modules may be composed of one program. One module may be composed of multiple programs. Multiple modules may be executed by a single computer. A single module may be executed by multiple computers in a distributed environment or a parallel environment. One module may include another module. In the discussion that follows, a “connection” refers to not only a physical connection but also a logical connection (such as an exchange of data, instructions, and data reference relationship). The word “predetermined” means that something is decided in advance of a process of interest. The word “predetermined” is thus intended to refer to something that is decided in advance of a process of interest in the exemplary embodiment. Even after a process in the exemplary embodiment has started, the word “predetermined” refers to something that is decided in advance of a process of interest depending on a condition or a status of the exemplary embodiment at the present point of time or depending on a condition or status heretofore continuing down to the present point of time. If “predetermined values” are plural, the predetermined values may be different from each other, or two or more of the predetermined values (including all the values) may be equal to each other. A statement that “if A, B is to be performed” is intended to mean that it is determined whether something is A, and that if something is determined as A, an action B is carried out. The statement becomes meaningless if the determination as to whether something is A is not performed.

The word “system” and the word “apparatus” refer to an arrangement where multiple computers, a hardware structure, and an apparatus are interconnected via a communication network (including a one-to-one communication connection). The word “system” and the word “apparatus” also refer to an arrangement that includes a single computer, a hardware structure, or an apparatus. The word “system” and the word “apparatus” have the same definition and are interchangeable with each other. The system in the context of the exemplary embodiment does not include a social system that is a social arrangement formulated by humans.

At each process performed by a module, or at one of the processes performed by a module, information as a process target is read from a memory device, the information is then processed, and the process results are written onto the memory device. A description related to the reading of the information from the memory device prior to the process and the writing of the processed information onto the memory device subsequent to the process may be omitted as appropriate. The memory devices may include a hard disc, a random access memory (RAM), an external storage medium, a memory device connected via a communication line, and a register within a central processing unit (CPU).

An information processing apparatus as an exemplary embodiment calculates a reducible sheet count of each print requester. As illustrated in FIG. 1, the information processing apparatus includes print attribute setting module 110, print job log management module 120, print job log memory 130, print target calculation module 140, print target memory 150, energy-saving action creation module 160, and energy-saving action memory 170. The phrase “print job” refers to a print process that is performed in response to a print instruction.

The print attribute setting module 110 is connected to the print job log management module 120. When printing is performed, the print attribute setting module 110 receives a reason why a setting other than a predetermined print setting is entered by a print requester (hereinafter also referred to as a user) by operating a keyboard, a mouse, a touchpanel, or the like. By setting any information as an attribute during printing, the print attribute setting module 110 provides the information to the print job log memory 130. The information set herein is “intentional untriggered print sheet reduction” attribute as the “setting other than the predetermined print setting.” The “predetermined print setting” is a setting for reducing a sheet count of printed paper sheets as a print medium. “Reducing the sheet count” may include reducing environment load, reducing print costs, and reserving a storage space. More specifically, the setting may include duplex N-up printing. The term “N-up” refers to a function that merges plural (N) pages into a single page and then outputs the single page (or merges plural images into a single image, and outputs the single image). For example, an action of merging two pages into one is referred to as 2-up. The action is also referred to as a contraction layout, a merging copying (printing), or “N in 1” operation.

The reason received by the print attribute setting module 110 may be a predetermined reason. The predetermined reasons may include a default reason, or one of the most frequently quoted reasons by print requesters. A predetermined reason may be set in accordance with a document name of a document to be printed, a stage of a workflow of a document to be printed performed by a document management system (indicating which of operations is at work in the workflow), and contents of a document to be printed. For example, if “company AA (predetermined client name)” is written at a predetermined position of a document to be printed, a print setting other than duplex N-up printing is input because the printing is intended for an “external user.”

The print job log management module 120 is connected to the print attribute setting module 110, the print job log memory 130, and the print target calculation module 140. The print job log management module 120 makes management of a print job log of a user (including storing, searching for and deleting the print job). The job log refers to a history of printing (including a print process and a print instruction). The print job log management module 120 causes an attribute set by the print attribute setting module 110 to be stored onto the print job log memory 130.

The print job log memory 130 is connected to the print job log management module 120. The log of printings stored by the print job log memory 130 includes information identifying a print requester, a sheet count of sheets printed in response to a single print instruction, and information identifying whether the printing has been performed at a predetermined print setting. For example, the print job log memory 130 stores a print attribute table 400, a print log table 700, and a per-user-based energy-saving untriggered data table 800.

The print target calculation module 140 is connected to the print job log management module 120, the print target memory 150, and the energy-saving action creation module 160. The print target calculation module 140 calculates an energy-saving print target on a per print requester basis in view of past prints of each requester. Using the print log, the print target calculation module 140 collects information about:

(1) total sheet count of the sheets printed on a per print requester basis during a predetermined period of time,

(2) sheet count of the sheets printed at a predetermined print setting on a per print requester basis during the predetermined period of time, and

(3) sheet count of the sheets printed at a setting other than the predetermined print setting on a per print requester basis during the predetermined period of time and for the very reason of the setting other than the predetermined print setting. In each of the sheet counts (1), (2), and (3), the “predetermined period of time” refers to the same length of time, and may be a period of one or more years or a period of one or more months, for example. In accordance with the collected information, the print target calculation module 140 calculates a reducible sheet count of each print requester.

In accordance with the calculated reducible sheet count, the print target calculation module 140 may further calculate a target value on a print sheet reduction of each print requester included in a group such that a target value on a print sheet count reduction set for the group including plural print requesters is achieved. The phrase “in accordance with the calculated reducible sheet count” suggests an action in which print requesters are divided by target category (for example, a category defined by ranges of print sheet counts of the sheets reduced last year), and a target value is set for each target category. The target value set for each target category refers to a reduction rate (%) to a total print sheet count of a preceding period (last year, for example). The “group of plural requesters” (hereinafter also referred to as an office) may include an organization (an entire company, a division in the company, a section in the company, a group in the company, or a combination thereof), a group in a layout of an office (such as a group divided by a partition), and a group of persons authorized to use a given printer.

The print target calculation module 140 may assign the target value to a schedule of each print requester in accordance with the calculated target value and print log stored on the print job log memory 130.

The print target memory 150 is connected to the print target calculation module 140. As described below, the print target memory 150 stores a target category table 1100, a personal yearly target schedule table 1200, and a personal yearly target schedule and record table 1500.

The energy-saving action creation module 160 is connected to the print target calculation module 140, and the energy-saving action memory 170. The energy-saving action creation module 160 determines and provides an energy-saving action responsive to a print target achievement status of each print requester. The energy-saving action creation module 160 compares the target value assigned by the print target calculation module 140 with a total print sheet as a present record, extracts an action policy from the energy-saving action memory 170 that stores action policies for print sheet reduction, and then presents the action policy to the print requester.

The energy-saving action memory 170 is connected to the energy-saving action creation module 160. The energy-saving action memory 170 stores an energy-saving action table 1600 to be discussed later, for example.

Operation contents may be different from user to user. Even if a person does not perform duplex N-up printing, it does not necessarily mean that that person fails to make energy-saving efforts. For example, if a document, the printing of which is obliged to be simplex 1-up printed according to an office regulation, is printed, that printing may be intentional. To determine whether the print setting is intentional or not, a user 210 may be allowed to set “intention of untriggered energy-saving” during print requesting. In this way, the print job log memory 130 stores the intention of the printing.

The intention of the untriggered energy-saving may be set by referencing a file name of a file as a print target to determine whether the file is a specified file.

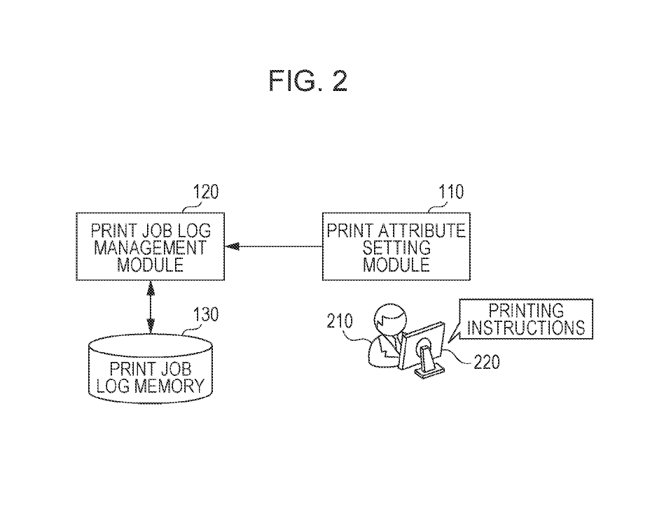

FIG. 2 illustrates a modular configuration of the exemplary embodiment. FIG. 2 illustrates the modules related to a process of storing the print log, (including the print attribute setting module 110, the print job log management module 120, and the print job log memory 130). The user 210 issues a print instruction to an information processing apparatus 220 by operating a keyboard, a mouse, a touchpanel, or the like. The print attribute setting module 110 is included in the information processing apparatus 220, which may be a personal computer (PC), for example. The print attribute setting module 110, the print job log management module 120, and the print job log memory 130 may be arranged in a single information processing apparatus or may be arranged in respective discrete information processing apparatuses that are linked via a communication line.

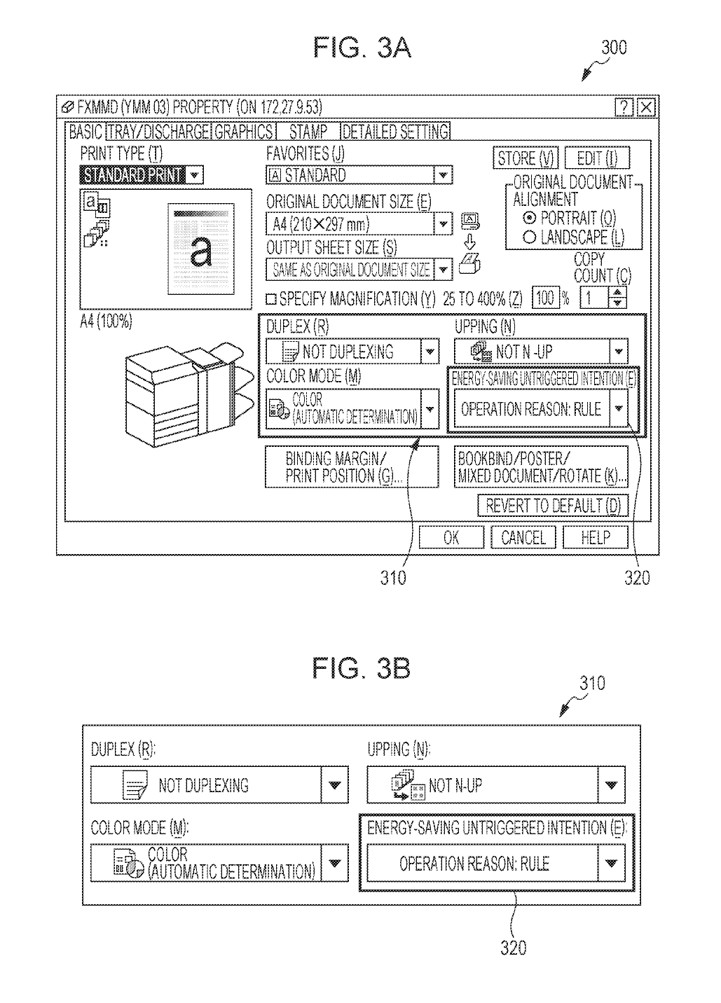

FIGS. 3A and 3B illustrate an example of a print attribute setting screen 300. The print attribute setting module 110 presents the print attribute setting screen 300 on a display, such as a liquid-crystal display of the information processing apparatus 220. For example, if a print instruction has been issued (e.g., a print button of an application has been pressed), the print attribute setting screen 300 is displayed on the display. The print attribute setting screen 300 includes a print attribute setting partition 310. The print attribute setting partition 310 includes energy-saving untriggered intention setting boxes 320. FIG. 3B illustrates part of the print attribute setting partition 310 in enlargement. For example, (A) “Operation reason” may be (A-1) Rule, and (A-2) External user. (B) “Ecological reason” may be (B-1) Use of recycled paper.

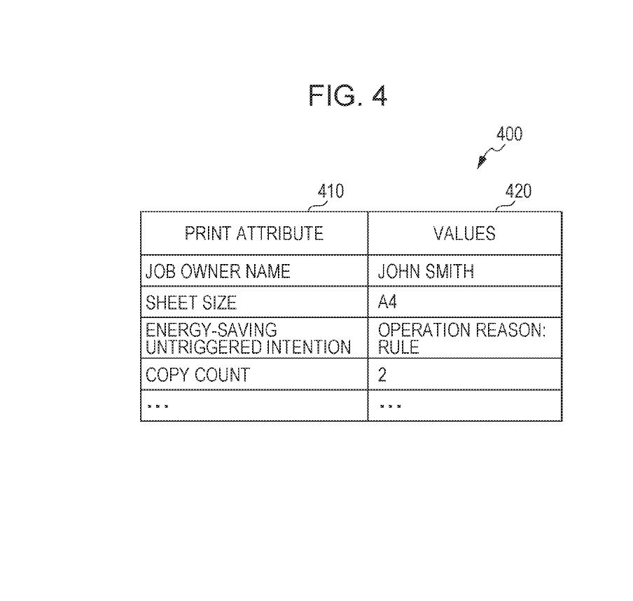

The print attribute setting module 110 receives the setting on the print attribute setting screen 300. The print job log management module 120 then stores the setting as the print attribute table 400 on the print job log memory 130. FIG. 4 illustrates a data structure of the print attribute table 400. The print attribute table 400 includes a print attribute column 410 and a value column 420. The print attribute column 410 stores print attributes. The value column 420 stores respective values (information) of the print attributes. For example, the attributes may include a job owner name (information uniquely identifying a print requester in the exemplary embodiment), a paper sheet size, energy-saving untriggered intention, and the number of copies. Also stored besides these pieces of information may be time and date of a print instruction (seconds, time units less than second, day, month, year, or a combination thereof), a file name of a file to be printed, and the number of pages to be printed. The sheet count of the sheets printed in response to the print instruction may be calculated by multiplying the number of pages by a copy count.

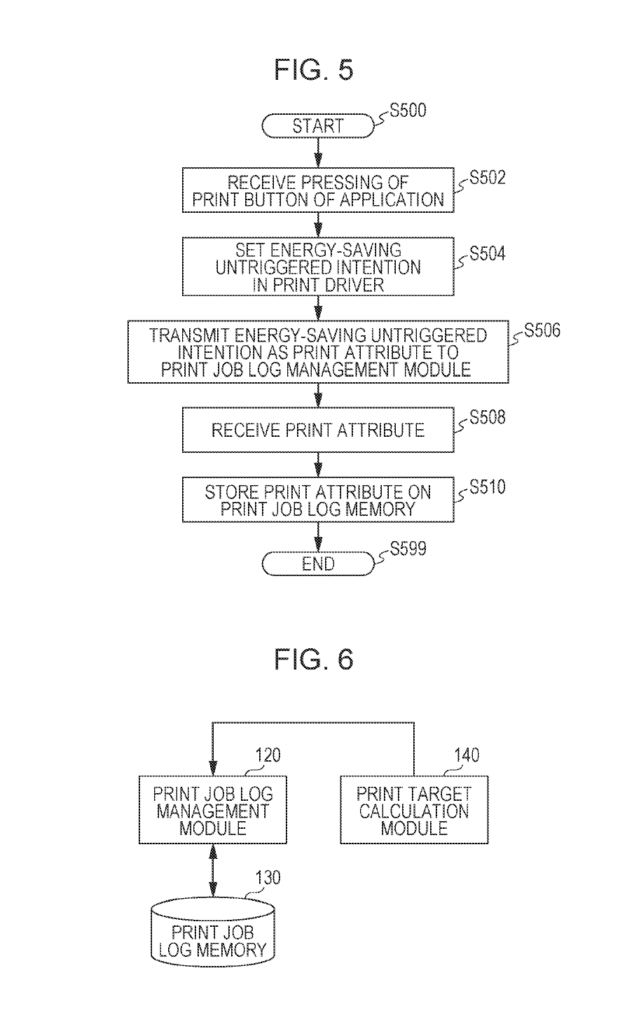

FIG. 5 is a flowchart illustrating an example of a process of the exemplary embodiment.

In step S502, the print attribute setting module 110 receives the pressing of a print button on an application.

In step S504, the print attribute setting module 110 sets energy-saving untriggered intention on a printer driver.

In step S506, the print attribute setting module 110 transmits the energy-saving untriggered intention (a value set in the energy-saving untriggered intention setting boxes 320) as a print attribute to the print job log management module 120.

In step S508, the print job log management module 120 receives the print attribute.

In step S510, the print job log management module 120 stores the print attribute on the print job log memory 130.

FIG. 6 illustrates a modular configuration of an example of the exemplary embodiment. FIG. 6 illustrates the modules related to a process of calculating a reducible sheet count (including the print job log management module 120, the print job log memory 130, and the print target calculation module 140). The print job log management module 120, the print job log memory 130, and the print target calculation module 140 may be arranged in a single information processing apparatus or may be arranged in respective discrete information processing apparatuses that are linked via a communication line.

The print target calculation module 140 collects and extracts the following information from the print job log on the print job log memory 130 on a per user basis.

Total print sheet count: the number of sheets actually printed

Print sheet count of the sheets to be duplex N-up printed: the number of sheets assuming that all the sheets of the specified sheet count to be duplex N-up printed have been printed

Print sheet count of the sheets intentionally not duplex N-up printed: The number of sheets intentionally not duplex N-up printed

Based on these pieces of information, the print target calculation module 140 determines the reducible sheet count in view of work of each user and energy-saving efforts as follows:

Reducible sheet count=(total sheet count)−(sheet count to be duplex N-up printed)−(sheet count intentionally not duplex N-up printed).

For example, the reducible sheet count of John Smith in January may be calculated to be 20−10−2=8. The total reducible sheet count of John Smith last year may be 60 sheets, for example.

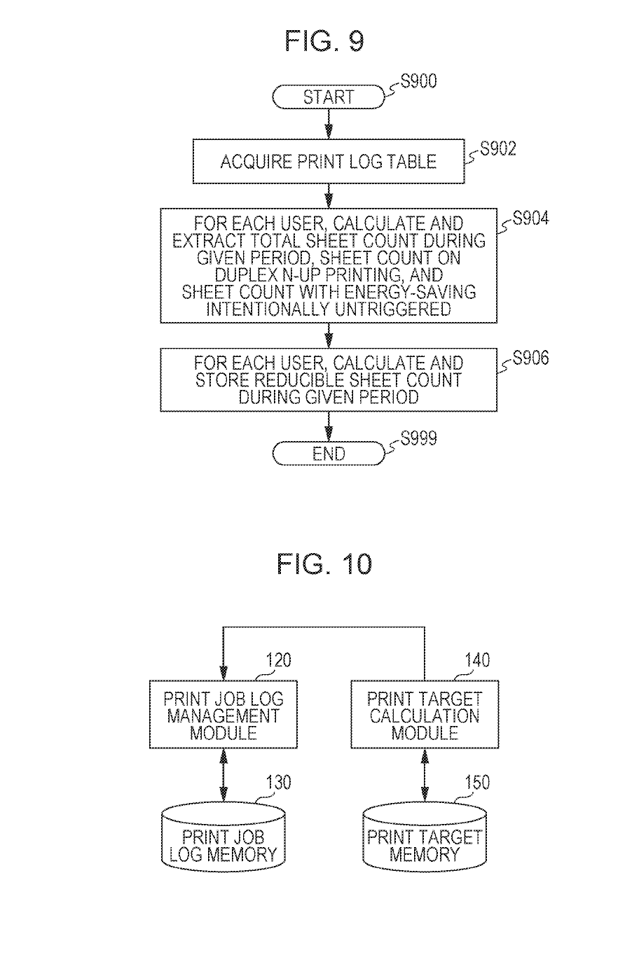

FIG. 9 is a flowchart illustrating an example of a process of the exemplary embodiment.

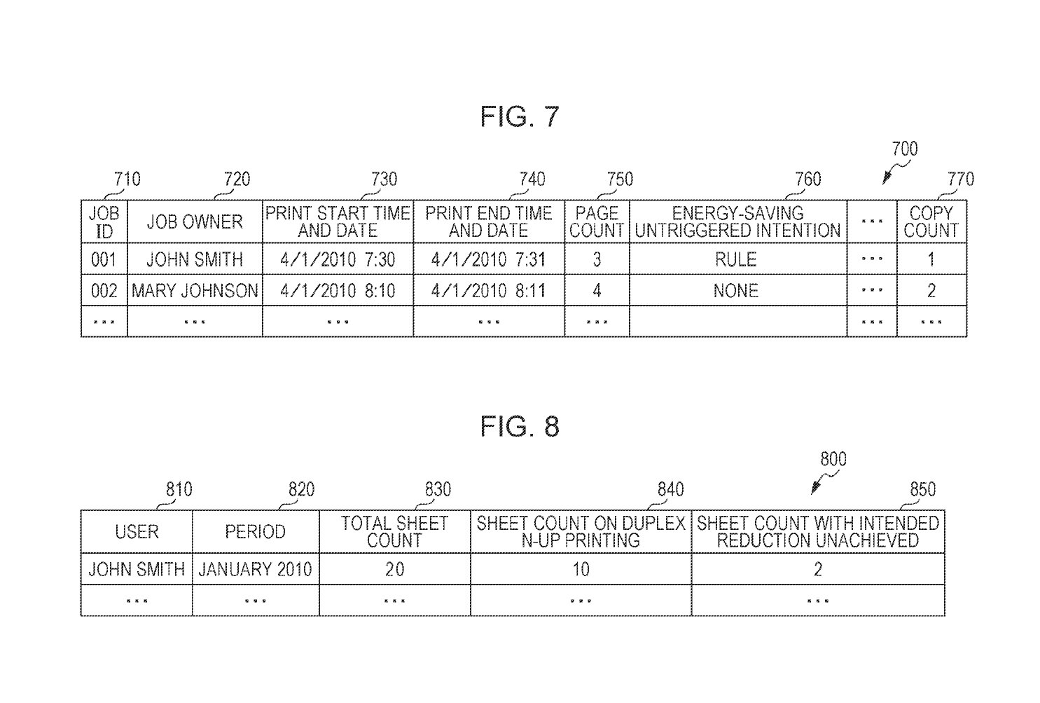

In step S902, the print target calculation module 140 acquires the print log table 700 from the print job log memory 130 via the print job log management module 120. FIG. 7 illustrates an example of a data structure of the print log table 700. The print log table 700 includes job identity (ID) column 710, job owner column 720, print start time and date column 730, print end time and date column 740, page count column 750, energy-saving untriggered intention column 760, copy count column 770, and the like. The print log table 700 corresponds to the print attribute table 400. The job ID column 710 stores information that uniquely identifies a print requester in the exemplary embodiment. The job owner column 720 stores the name of a print requester. The print start time and date column 730 stores time and date on which printing starts. The print end time and date column 740 stores time and date on which the printing ends. The page count column 750 stores the number of printed pages. The energy-saving untriggered intention column 760 stores a reason why a setting other than a predetermined setting is input in the printing. The copy count column 770 stores the number of printout copies.

In step S904, the print target calculation module 140 collects and extracts, on each user, information about the total print sheet count, the sheet count to be duplex N-up printed, and the sheet count intentionally left unreduced.

In step S906, the print target calculation module 140 calculates and stores a reducible sheet count for each user during a given period of time. For example, the reducible sheet count may be stored as the per-user-based energy-saving untriggered data table 800 on the print job log memory 130. FIG. 8 illustrates an example of a data structure of the per-user-based energy-saving untriggered data table 800. The per-user-based energy-saving untriggered data table 800 includes user column 810, period column 820, total sheet count column 830, duplex N-up printed sheet count column 840, and intentionally unreduced sheet count column 850. The user column 810 stores a name of a print requester. The period column 820 stores a period of interest. The total sheet column 830 stores the print total sheet count during the period (as previously defined in the sheet count definition (1)). The duplex N-up printed sheet count column 840 stores the sheet count of the sheets to be N-up printed during the period (as previously defined in the sheet count definition (2)). The intentionally unreduced sheet count column 850 stores the sheet count intentionally left unreduced (as previously defined in the sheet count definition (3)).

FIG. 10 illustrates a module configuration of one structure of the exemplary embodiment. FIG. 10 illustrates the modules related to a process of calculating a target value of the reducible sheet count (including the print job log management module 120, the print job log memory 130, the print target calculation module 140, and the print target memory 150). The print job log management module 120, the print job log memory 130, the print target calculation module 140, and the print target memory 150 may be arranged in a single information processing apparatus or may be arranged in respective discrete information processing apparatuses that are linked via a communication line.

This year's target of an office may be “10% reduction in the sheet count of the sheets used last year (4500 sheets this year to 5000 sheets last year).” The office's target may be achieved by all the users in the office together. In accordance with the exemplary embodiment, the individual target achievement effort of each user and the group target achievement effort of the entire office may be balanced such that the individual target and the group target may be set in view of the business operation of each user (work responsibility of each user).

The above example is based on the premise that there is no change in the overall output sheet count between last year and this year. If a difference is expected to occur in the overall output sheet count, an adjustment coefficient, such as up 10% or down 15%, may be introduced.

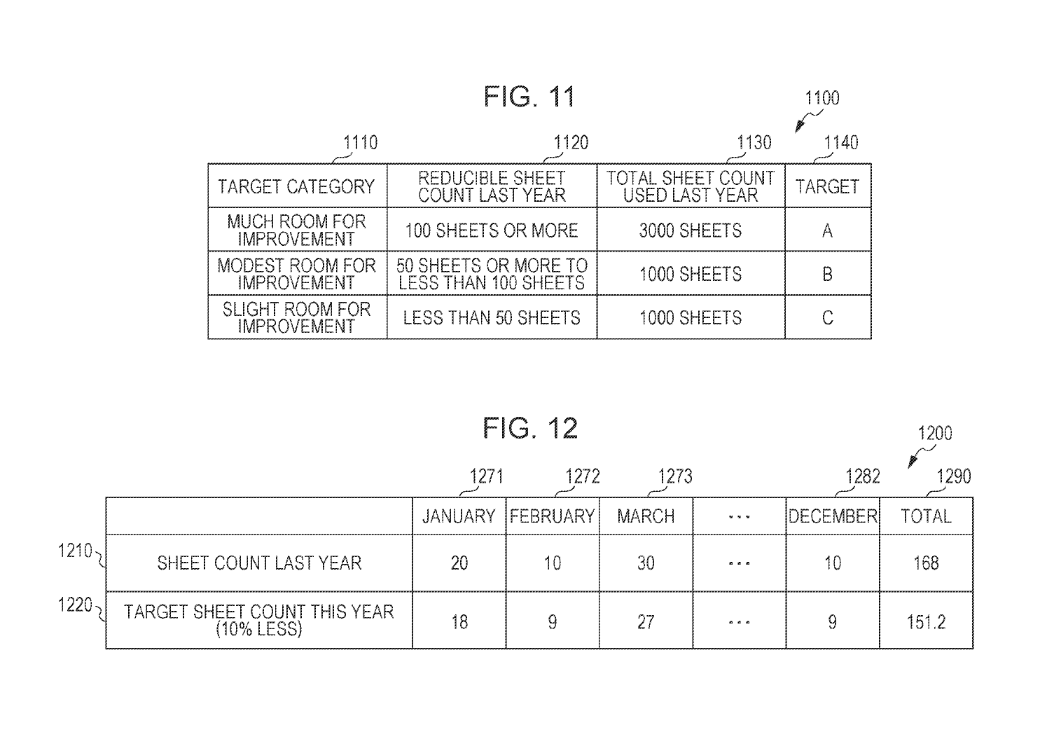

The print target memory 150 stores the target category table 1100 and the personal yearly target schedule table 1200. FIG. 11 illustrates a data structure of the target category table 1100. The target category table 1100 includes target category column 1110, last year reducible sheet count column 1120, last year used total sheet count column 1130, and target value column 1140. The target category column 1110 stores names of target categories (including “much room for improvement,” “modest room for improvement,” and “slight room for improvement”). The last year reducible sheet count column 1120 stores predetermined criteria for categorization (herein including “100 sheets or more,” “from 50 sheets or more to less than 100 sheets,” and “less than 50 sheets”). The last year used total sheet count column 1130 stores the sheet count of the sheets used by all the users last year corresponding to the last year reducible sheet count column 1120. The target value column 1140 stores a target value as a reduction target this year.

The print target calculation module 140 calculates a value of the last year used total sheet count column 1130 of all the users with respect to the criteria of the last year reducible sheet count column 1120. For example, parameters A, B, and C satisfying relationship of A>B>C (respectively indicating what percent reduction is acceptable) may be determined. The relationship of A>B>C is defined to ensure that no partiality is introduced in target setting.

For example, the parameters A, B, and C may be decided such that a relationship of 4500 sheets=3000 sheets×A+1000 sheets×B+1000 sheets×C (a 10 percent reduction of the sheet counts of the sheets used last year) holds. For example, an entire office target reduction of 10 percent may be achieved by A=13%, B=10%, and C=5%.

The print target calculation module 140 may calculate a distribution of the reducible sheet count last year, determine whether a chance of improvement is expected in accordance with the distribution, and set a target value only if the change of improvement is expected. If the number of persons who were assigned the reducible sheet count in a given category last year is smaller than a predetermined number of persons, the print target calculation module 140 may determine that the chance of improvement is low, and then set no target value in that category.

For example, if a target category to which John Smith belongs to is “modest room for improvement” (=10% reduction), the yearly target schedule may become a personal yearly target schedule table 1200. FIG. 12 illustrates a data structure of the personal yearly target schedule table 1200. The personal yearly target schedule table 1200 includes last year sheet count row 1210, and this year sheet count (10 percent reduction) row 1220 in a column direction, and January column 1271, February column 1272, March column 1273, . . . , December column 1282, and total column 1290 in a row direction. More specifically, the personal yearly target schedule table 1200 stores the last year record and this year's target values in use (10 percent reduced value of the sheet count used at the same month last year). These values are generated by the print target calculation module 140.

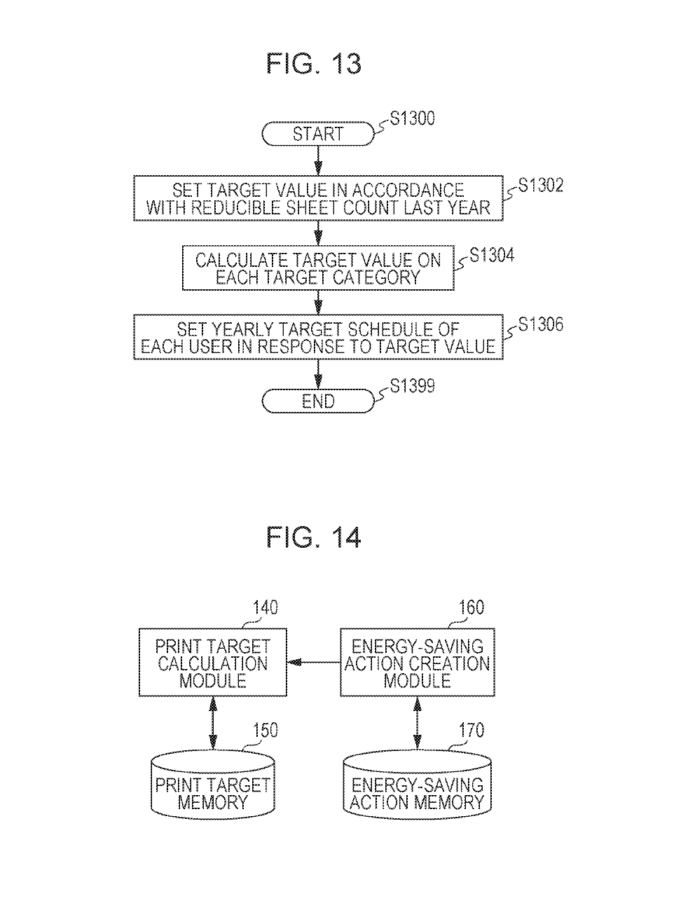

FIG. 13 is a flowchart illustrating an example of a process of the exemplary embodiment.

In step S1302, the print target calculation module 140 sets a target value in accordance with the reducible sheet count last year.

In step S1304, the print target calculation module 140 calculates a target value of each target category.

In step S1306, the print target calculation module 140 generates a yearly target schedule of each user in response to the target value.

FIG. 14 illustrates a modular configuration of the exemplary embodiment. FIG. 14 illustrates the modules related to a process of calculating a target value of the reducible sheet count (including print target calculation module 140, print target memory 150, energy-saving action creation module 160, and energy-saving action memory 170). The print target calculation module 140, the print target memory 150, the energy-saving action creation module 160, and the energy-saving action memory 170 may be arranged in a single information processing apparatus or may be arranged in respective discrete information processing apparatuses that are linked via a communication line.

In accordance with the exemplary embodiment, a process of presenting an energy-saving action is performed in accordance with the record this year and the personal yearly target schedule table 1200.

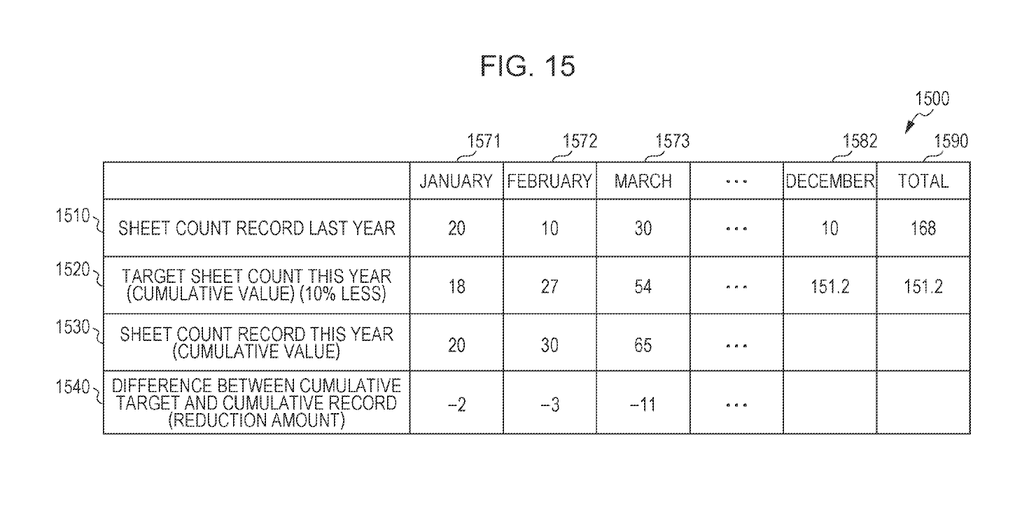

The print target memory 150 stores the personal yearly target schedule and record table 1500. FIG. 15 illustrates a data structure of the personal yearly target schedule and record table 1500. The personal yearly target schedule and record table 1500 includes last year sheet count record row 1510, this year target sheet count (cumulative value) (10% less) row 1520, this year sheet count record (cumulative value) row 1530, and difference between cumulative target and cumulative record (reduction amount) row 1540 in a column direction. The personal yearly target schedule and record table 1500 also includes January column 1571, February column 1572, March column 1573, . . . , December column 1582, and total column 1590 in a row direction. The print target calculation module 140 generates the personal yearly target schedule and record table 1500. The last year sheet count record row 1510 in the personal yearly target schedule and record table 1500 remains the same as the last year sheet count row 1210 in the personal yearly target schedule table 1200. The value in this year target sheet count (cumulative value) (10% less) row 1520 is calculated down to the month using this year sheet count (10 percent reduction) row 1220 in the personal yearly target schedule table 1200. The value in this year sheet count record (cumulative value) row 1530 is calculated using the print log this year. The value in the difference between cumulative target and cumulative record (reduction amount) row 1540 is calculated by subtracting the value in this year sheet count record (cumulative value) row 1530 from the value in this year target sheet count (cumulative value) (10% less) row 1520.

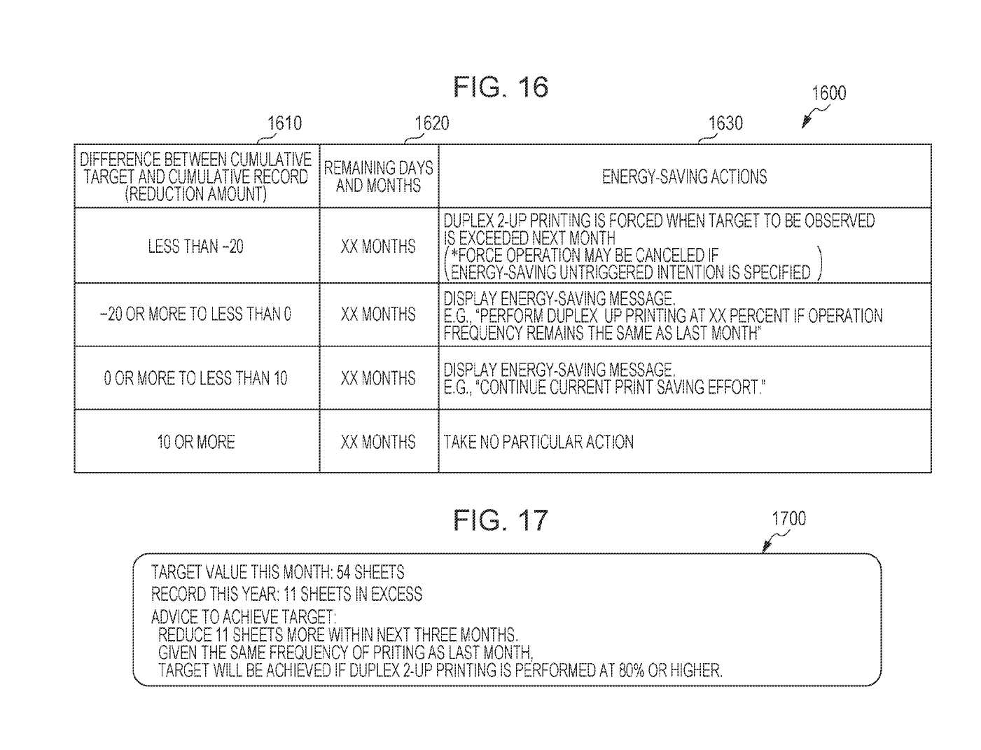

The energy-saving action memory 170 stores an energy-saving action table 1600. FIG. 16 illustrates a data structure of the energy-saving action table 1600. The energy-saving action table 1600 includes difference between cumulative target and cumulative record (reduction amount) column 1610, remaining day or month column 1620, and energy-saving action column 1630. The difference between cumulative target and cumulative record (reduction amount) column 1610 stores a criterion according to which the energy-saving action is taken. The criterion here is the difference between the target value and the record value (the value of the difference between cumulative target and cumulative record (reduction amount) row 1540 in the personal yearly target schedule and record table 1500). The remaining day or month column 1620 stores a remaining day or a remaining month in this year serving as a criterion of the energy-saving action. The energy-saving action column 1630 stores an energy-saving action that is performed when the criteria of the difference between cumulative target and cumulative record (reduction amount) column 1610, and the remaining day or month column 1620 are met. The print attribute setting module 110 performs a process in accordance with the energy-saving action column 1630.

For example, as long as a yearly target is achieved, setting a monthly target each month may be omitted. If target values (for example, the criteria of the difference between cumulative target and cumulative record (reduction amount) column 1610, and the remaining day or month column 1620) in the energy-saving action table 1600 are definitely exceeded, force update to duplex N-up printing is performed when the target values are exceeded next month. If the energy-saving untriggered intention has been specified, force setting may be canceled. Other energy-saving actions may include displaying an energy-saving message stating “perform duplex N-up printing at xx percent if operation frequency remains the same as last month, displaying another energy-saving message stating “continue current print saving effort,” and taking no particular action. Optionally, a specific target value to achieve the energy-saving target may be calculated in accordance with a predetermined rule.

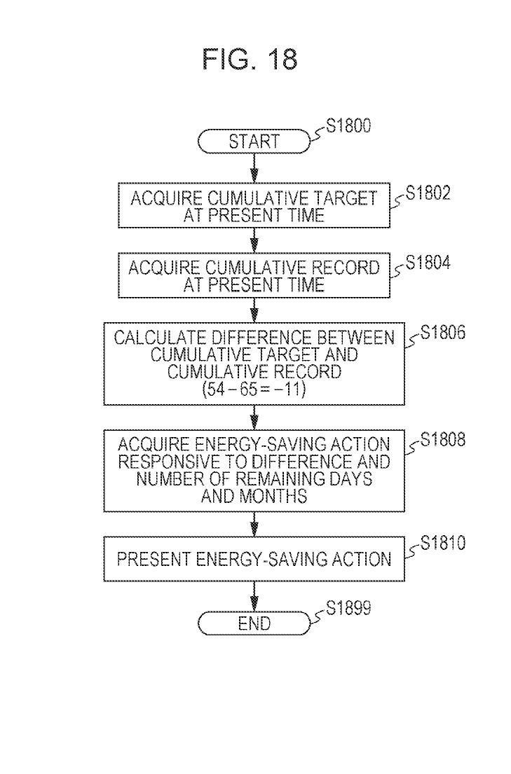

FIG. 18 is a flowchart illustrating an example of a process of the exemplary embodiment.

In step S1802, the energy-saving action creation module 160 acquires a current cumulative target.

In step S1804, the energy-saving action creation module 160 acquires a current cumulative record.

In step S1806, the energy-saving action creation module 160 calculates a difference between the current cumulative target and the current cumulative record. For example, in March in the example of FIG. 15, 54−65=−11.

In step S1808, the energy-saving action creation module 160 acquires an energy-saving action responsive to the difference value and the remaining day or month. The energy-saving action creation module 160 extracts data in the energy-saving action column 1630 in the energy-saving action table 1600.

In step S1810, the energy-saving action creation module 160 presents the energy-saving action. For example, an energy-saving action comment 1700 is displayed on a display of an information processing apparatus on which the user has input a print instruction. FIG. 17 illustrates an example of the energy-saving action comment 1700.

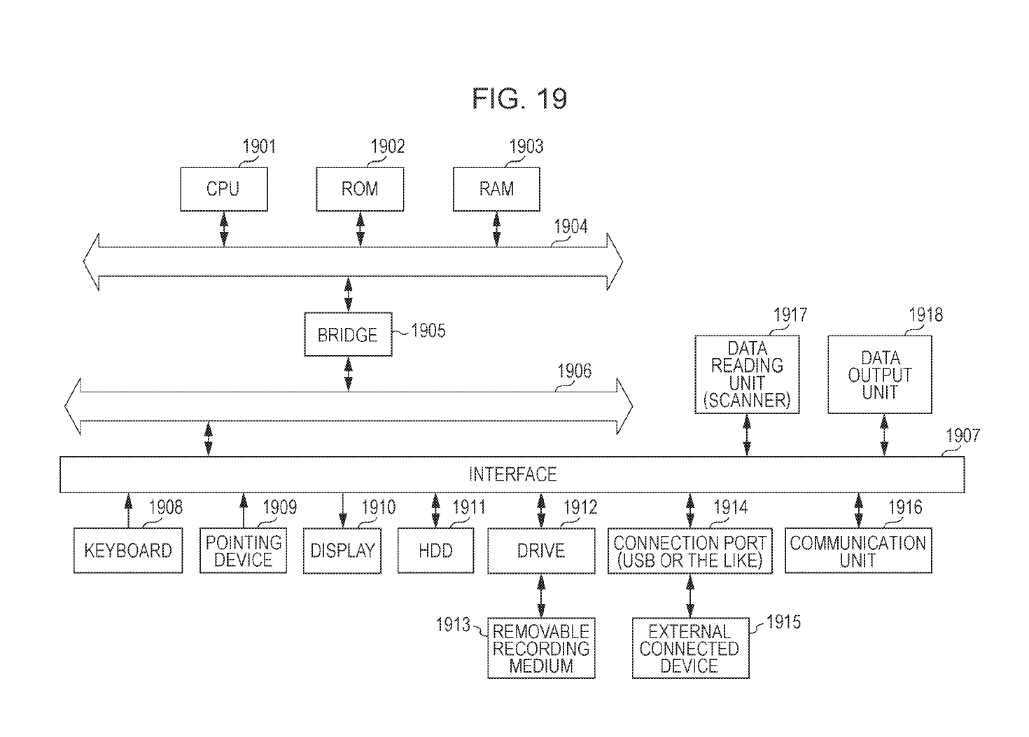

A hardware configuration of the information processing apparatus of the exemplary embodiment is described referring to FIG. 19. The information processing apparatus of FIG. 19 may be implemented using a personal computer (PC). The information processing apparatus further includes a data reading unit 1917, such as a scanner, and a data output unit 1918, such as a printer.

A central processing unit (CPU) 1901 is a controller that performs a process in accordance with a computer program of an execution sequence of the variety of modules described above. The modules include the print attribute setting module 110, the print job log management module 120, the print target calculation module 140, and the energy-saving action creation module 160.

A read-only memory (ROM) 1902 stores programs used by the CPU 1901, and arithmetic parameters. A random-access memory (RAM) 1903 stores the programs used by the CPU 1901 when the CPU 1901 operates, and parameters that vary as appropriate in the operation of the CPU 1901. These elements are interconnected via a host bus 1904 including a CPU bus.

The host bus 1904 is connected to an external bus 1906 such as a peripheral component interconnect/interface (PCI) bus via a bridge 1905.

A keyboard 1908, and a pointing device 1909 such as a mouse, are input devices operated by a user. A display 1910 includes a liquid-crystal display device or a cathode-ray tube (CRT), and displays a variety of information in the form of text or image information.

A hard disk drive (HDD) 1911 includes and drives a hard disk, and records and reproduces the program executed by the CPU 1901 and information. The hard disk stores the print attribute table 400, the print log table 700, the per-user-based energy-saving untriggered data table 800, the target category table 1100, the personal yearly target schedule table 1200, the personal yearly target schedule and record table 1500, the energy-saving action table 1600, etc. The hard disk further stores a variety of data processing programs, and a variety of computer programs.

A drive 1912 reads data or programs stored on a removable recording medium 1913 including a magnetic disk, an optical disk, a magneto-optical disk, a semiconductor memory or the like, and then transfers the data or the program to the RAM 1903 via an interface 1907, the external bus 1906, the bridge 1905, and the host bus 1904. The removable recording medium 1913 may be usable as a data recording region in the same manner as the hard disk.

A connection port 1914 connects to an external connected device 1915, and includes universal serial bus (USB) connection, and IEEE1394 connection. The connection port 1914 is connected to the CPU 1901 and the like via the interface 1907, the external bus 1906, the bridge 1905, the host bus 1904, and the like. A communication unit 1916 is connected to a communication line and performs a data communication process with the outside. The data reading unit 1917 may be a scanner, for example, and performs a document reading operation. The data output unit 1918 may be printer, for example, and performs an output process of document data.

The hardware configuration of the information processing apparatus of FIG. 19 is discussed for exemplary purposes only. The exemplary embodiment is not limited to this hardware configuration of FIG. 19 and may be acceptable in any form as long as the modules of the exemplary embodiment are implemented. For example, one module may be implemented using an application specific integrated circuit (ASIC) or the like. In another example, one module may be in an external system and connected to the system of FIG. 19. In yet another example, elements in the system of FIG. 19 may be interconnected to each other via a communication line such that the elements operate in concert with each other. The elements may be incorporated into a photocopier, a facsimile machine, a scanner, a printer, a multi-function apparatus (an image processing apparatus having at least two functions of the scanner, the printer, the photocopier, and the facsimile machine).

The above-described program may be supplied in a stored state on a recording medium. The program may also be provided via a communication unit. In such a case, the above-described program may be understood as an invention of a “non-transitory computer readable recording medium storing the program.”

The “non-transitory computer readable recording medium storing the program” refers to a computer readable recording medium storing the program, and used to install the program, to execute the program, or to distribute the program.

The recording media include digital versatile disc (DVD), compact disc (CD), Blu-ray disc (registered trademark), magnetooptical disc (MO), flexible disc (FD), magnetic tape, hard disc, read-only memory (ROM), electronically erasable and programmable read-only memory (EEPROM (registered trademark)), flash memory, random-access memory (RAM), and secure digital (SD) memory card. The DVDs include “DVD-R, DVD-RW, and DVD-RAM” complying with the standard formulated by the DVD forum, and “DVD+R and DVD+RW” complying with DVD+RW standards. The CDs include read-only CD (CD-ROM), recordable CD-R, and rewritable CD-RW.

The program in whole or in part may be stored on the recording medium for storage and distribution. The program in whole or in part may be transmitted via a transfer medium. The transfer media include a wired network, a wireless network, or a combination thereof. The wired networks include a local-area network (LAN), a metropolitan-area network (MAN), a wide-area network (WAN), the Internet, an intranet, and an extranet. The program in whole or in part may be transmitted over a carrier wave.

The program may be part of another program, or may be stored on the recording medium together with another program. The program may be split and split programs may then be stored on the recording medium. The program may be processed in any fashion before being stored as long as the program remains restorable. For example, the program may be compressed or encrypted before storage.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus, comprising:
a receiving unit that receives a reason why to input a setting other than a predetermined print setting when printing is performed; and
a calculating unit that, using a print log, collects a total print sheet count of sheets printed for each print requester, a print sheet count of sheets printed at the predetermined print setting, and a print sheet count of sheets printed for the reason, and calculates a reducible print sheet count of the print requester in accordance with calculated information of the print sheet counts.

2. The information processing apparatus according to claim 1, further comprising a second calculating unit that calculates a reduction target value of a print sheet count for the print requester included in a group of requesters such that a reduction target value set on a print sheet count for the group is achieved in accordance with the reducible print sheet count calculated by the calculating unit.

3. The information processing apparatus according to claim 2, further comprising an assignment unit that assigns a target value to a schedule of the print requester in accordance with the reduction target value calculated by the second calculating unit and the print log.

4. The information processing apparatus according to claim 3, further comprising a presenting unit that compares the target value assigned by the assignment unit with a total print sheet count as a current record, reads an action policy from a memory that stores action policies for print sheet reduction, and presents the action policy.

5. The information processing apparatus according to claim 1, the reason received by the receiving unit is a predetermined reason.

6. The information processing apparatus according to claim 2, the reason received by the receiving unit is a predetermined reason.

7. The information processing apparatus according to claim 3, the reason received by the receiving unit is a predetermined reason.

8. The information processing apparatus according to claim 4, the reason received by the receiving unit is a predetermined reason.

9. An information processing method, comprising:
receiving a reason why to input a setting other than a predetermined print setting when printing is performed; and
collecting, using a print log, a total print sheet count of sheets printed for each print requester, a print sheet count of sheets printed at the predetermined print setting, and a print sheet count of sheets printed for the reason, and calculating a reducible print sheet count of the print requester in accordance with calculated information of the print sheet counts.

10. A non-transitory computer readable medium storing a program causing a computer to execute a process for processing information, the process comprising:
receiving a reason why to input a setting other than a predetermined print setting when printing is performed; and
collecting, using a print log, a total print sheet count of sheets printed for each print requester, a print sheet count of sheets printed at the predetermined print setting, and a print sheet count of sheets printed for the reason, and calculating a reducible print sheet count of the print requester in accordance with calculated information of the print sheet counts.
